(19) United States
(12) Patent Application Publication
(10) Pub. No.: US 2011/0304148 A1
(43) Pub. Date: Dec. 15, 2011

(54) HYDROELECTRIC TURBINE SUPPORT SYSTEM

(75) Inventors: Paul Dunne, Dublin (IE); James Ives, Dublin (IE)

(73) Assignee: OPENHYDRO IP LIMITED, Dublin (IE)

(21) Appl. No.: 13/133,504

(22) PCT Filed: Dec. 14, 2009
(86) PCT No.: PCT/EP09/08941

§ 371 Date: Aug. 23, 2011

(30) Foreign Application Priority Data
Dec. 18, 2008 (EP) 08021970.2

(51) Int. Cl. F03B 13/10

(52) U.S. Cl. 290/54

(57) ABSTRACT

The present invention provides a hydroelectric turbine support system, and in particular the combination of a base on which the turbine is supported on the seabed during use, and a vessel used to transport the turbine and base to a deployment site, and which are designed to allow, when the system is docked at a quayside or the like, the base to contact the seabed during periods of low tide and to support the vessel thereon during such periods, without damage to either the base or the vessel.

### FIELD OF THE INVENTION

The present invention is concerned with a hydroelectric turbine support system, and in particular the combination of a base on which the turbine is supported on the seabed, and a vessel used to transport the turbine and base to a deployment site, and which are designed to allow deployment from a larger number of onshore sites, for example from a relatively shallow quayside or from a slip.

### BACKGROUND OF THE INVENTION

Hydroelectric turbines are well known, and are generally deployed on the seabed in areas of high tidal flow in order to generate economic levels of electricity from the power of the tide. The use of hydroelectric turbines is now receiving significant attention due to the environmental damage that has been inflicted on the planet due to the long term use of fossil fuels such as coal and gas. Thus huge resources are being channeled into the development and deployment of renewable energy sources, for example hydroelectric power generation, and in particular tidal based hydroelectric generation.

However, with the implementation of such new methods of generating power are not without there own challenges. Focusing in particular on the generation of electricity from tidal resources, there are significant obstacles to be overcome in both maintaining hydroelectric turbines in good working condition while located on the seabed, in addition to both deploying and retrieving the turbines. The locations of good tidal resources will rarely coincide with locations at which larger ports or the like are located, thus making it difficult to deploy and retrieve the turbines, which require the use of significant onshore resources.

It is therefore an object of the present invention to design a hydroelectric turbine support system which allows a greater number of locations to be used in the deployment/retrieval of hydroelectric turbines.

According to a first aspect of the present invention there is provided a hydroelectric turbine support system comprising a vessel for transporting the turbine to a deployment site; a base on which the turbine is supportable, the base and vessel being designed to allow the base to be retained beneath the vessel; wherein the base and vessel are adapted to facilitate the stable support of the vessel above the base when the system is partially or fully out of water.

Preferably, the base and vessel are designed to allow the base to support the vessel while the base is free standing.

Preferably, the vessel and the base are provided with complementary coupling portions.

Preferably, the coupling portions substantially prevent the relative movement of the base and vessel when the system is partially or fully out of water.

Preferably, the coupling portions comprise at least one projection provided on or formed integrally with the base and a complementary socket provided on or formed integrally with the vessel.

Preferably, the projection and/or socket are tapered to assist in locating the projection in the socket.

Preferably, the base comprises at least one leg an upper end of which defines one of the complementary coupling portions.

Preferably, the base is free standing on a lower end of the at least one leg.

Preferably, the base comprises three legs each of which defines one complimentary coupling portion.

Preferably, the vessel is adapted to allow the turbine to be mounted to and supported by the base while the base is mounted beneath the vessel and supporting the vessel.

According to second aspect of the present there is provided a method of supporting a hydroelectric turbine system comprising the steps of:
securing a base of the system beneath a vessel of the system;
positioning the system in a body of water at a location at which the water depth varies over time;
and allowing the base to contact and stand on a bottom of the body of water, and therefore support the vessel at least partially out of the water during periods of low water depth.

Preferably, the method comprises the steps of
prior to securing the vase to the vessel, positioning the base of the system in a body of water;
locating the vessel above the base;
raising the base beneath the vessel to allow the base and vessel to be secured together.

Preferably, the method comprises the step of:
securing a turbine to the base once the base is secured beneath the vessel.

### BRIEF DESCRIPTION OF THE DRAWINGS

FIG. 1 illustrates a schematic representation of a hydroelectric turbine and support system according to a preferred embodiment of the present invention, and located at a first location during high tides;

FIG. 2 illustrates the support system of FIG. 1 at low tide;

FIG. 3 illustrates the hydroelectric turbine support system at a second location at high tide;

FIG. 4 illustrates the support system of FIG. 3 at low tide;

FIG. 5 illustrates the hydroelectric turbine support system of the present invention at a third location at high tide;

FIG. 6 illustrates the support system shown in FIG. 5 at low tide;

FIG. 7 illustrates the schematic representation of a base and vessel forming the system of the present invention, being brought together; and

FIG. 8 illustrates a perspective view of the arrangement illustrated in FIG. 7.

### DETAILED DESCRIPTION OF THE DRAWINGS

Referring now to the accompanying drawings there is illustrated a hydroelectric turbine support system, generally indicated as (10), which is adapted to enable the deployment of a hydroelectric turbine (not shown) from a large number of onshore locations, and which also allows the system (10) to be stored in areas of shallow water during low tide which would otherwise be unsuitable for the location of such a water borne deployment system.

The system (10) comprises a vessel (12) and a base (14) which is locatable and retainable beneath the vessel (12) as described in detail hereinafter. The hydroelectric turbine (not shown) may then be mounted to the base (14) and the vessel (12) used to transport the base (14) and turbine to an offshore deployment site. The vessel (12), in the preferred embodiment illustrated, is in the form of a barge which is towed to the deployment site by a tug or other suitable vessel, although it will be appreciated that the vessel (12) may be self powered.

In the embodiment illustrated the base (14) comprises three legs (16) disposed in a triangular array and connected together by a number of horizontally disposed tubular struts (18). It will of course be appreciated from the following description of the invention that the base (14) may be of any other suitable configuration, and for example may comprise more than three legs (16).

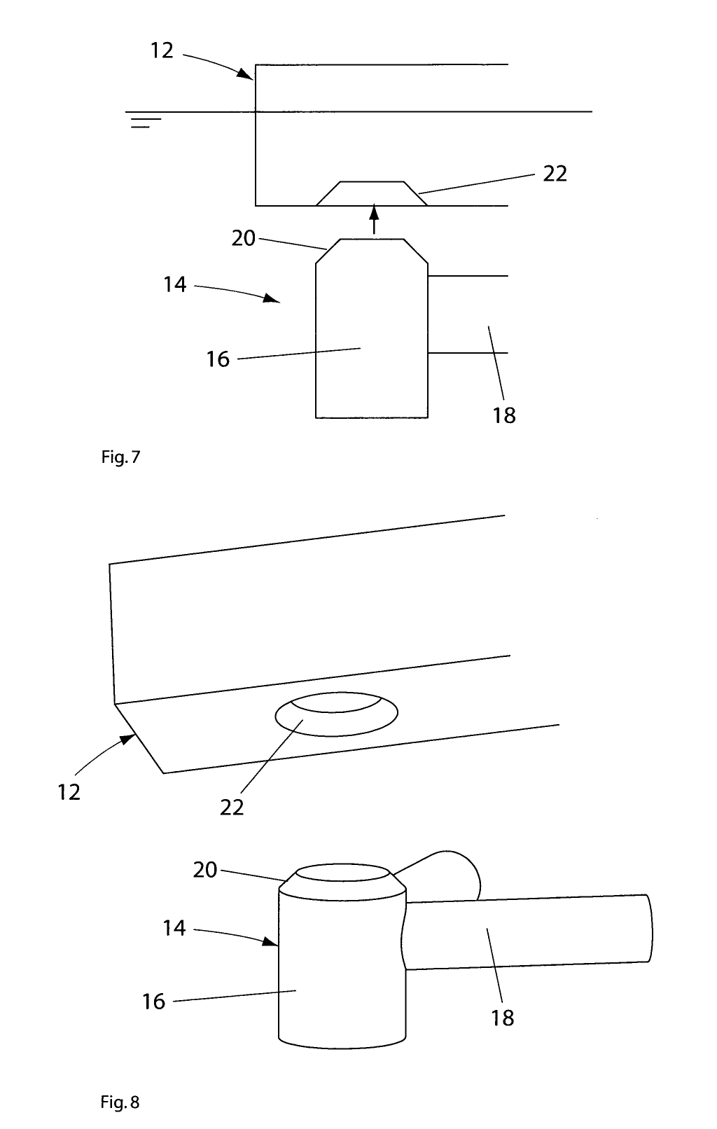

The base (14) and the vessel (12) are designed to define complimentary coupling portions which on the base take the form of a projection (20) formed at an upper end of each of the legs (16), as illustrated in FIGS. 7 and 8. On the vessel (12) the complimentary coupling portions takes the form of sockets (22) which are preferably formed integrally with a pontoon (26) of the vessel (12). The sockets (22) may of course be provided at any other suitable location or portion of the vessel (12), in particular on an underside thereof. The sockets (22) must of course be positioned to align with the projections (20) when the base (14) is brought into register with the vessel (14). The projections (20) and sockets (22) are complimentary in shape, and are preferably tapered as illustrated in order to simplify the location of the projections (20) within the sockets (22). Any other suitable means of guiding the projections (20) and sockets (22) into register with one another may be employed, in order to reduce the level of precision required when manoeuvring the two parts of the system (10) into position with one another.

Turning then to the operation of the support system (10), the vessel (12) and base (14) are designed to have a complimentary fit with one another, and in particular the base (14) may be secured beneath the vessel (12) as illustrated in FIGS. 4 and 6, such that the base (14) may be towed to a deployment site beneath the vessel (12). This provides the system (10) with a low centre of gravity and therefore significant stability, which is beneficial when manouevreing the system (10) is rough waters. In addition the vessel (12) and base (14) are designed such that the turbine (not shown) may be mounted on the base (14) while the base (14) is mounted beneath the vessel (12), and preferably such that the turbine is then located above and accessible from an upper deck of the vessel (12). This allows access to the turbine despite the base (14) being located underneath the vessel (12), allowing for any maintenance or last minute checks to be carried out on the turbine before deployment.

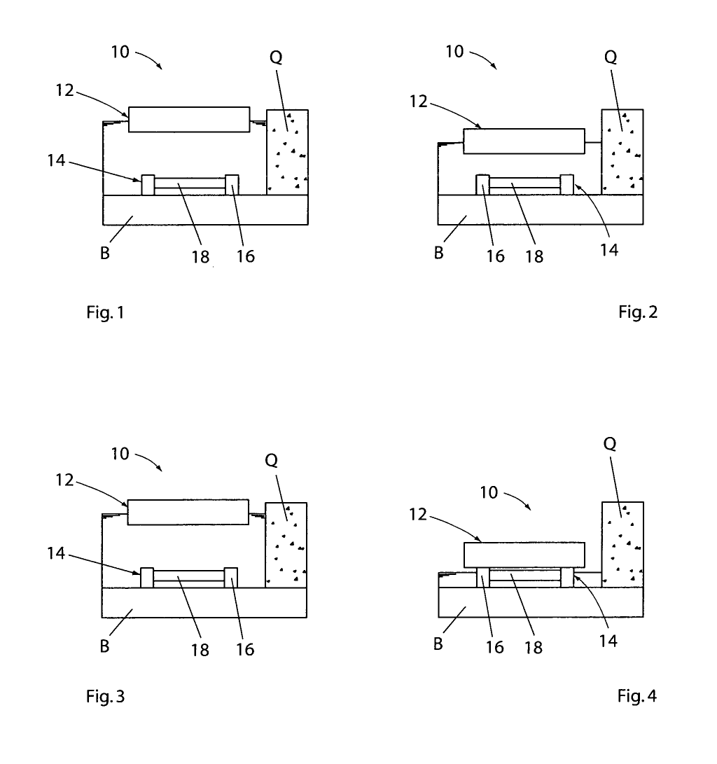

In the preferred embodiment illustrated in order to locate the base (14) beneath the vessel (12) the base (14) is first lowered onto the seabed (B), for example from a quay (Q) or the like as illustrated in FIGS. 1-4. The vessel (12) is then floated into position above the base (14), and the base (14) winched into position directly beneath and in contact with the vessel (12). The vessel (12) and the base (14) are then secured to one another by any suitable means. It is however envisaged that the vessel (12) and base (14) may be secured together in this arrangement while on shore, and subsequently deployed into the water as a combined unit. However such a procedure would require larger transport and lifting equipment, and is therefore less desirable.

Referring in particular to FIGS. 1-4 there are times when the system (10) will need to be retained at the quay (Q), whether for maintenance, testing, or some other reason, for extended periods. During the time that the system (10) is docked in the water at the quay (Q), the tide will be coming in and going out, thus resulting in variation in the depth of water at the quay (Q). FIGS. 1 and 2 illustrate the system (10) parked at a first location at the quay (Q), and showing the vessel (12) and base (14) separated from one another. FIG. 1 illustrates the system (10) at the quay (Q) during high tide, showing adequate clearance between the vessel (12) and the base (14). Essentially what this means is that during low tide the system (10) will not “dry out”, which means that the system (10) will remain in water deep enough to allow the vessel (12) to remain afloat and supporting the base (14) there beneath, with the base contacting the seabed (B). FIG. 2 illustrates the system (10) at the same location during low tide. Again there is adequate clearance between the vessel (12) and the base (14). Thus at such a location there is no risk of the base (14) fouling the seabed (B) during low tide, which could result in damage to the system (10).

Turning now to FIGS. 3 and 4, the system (10) is shown at a second location at the quay (Q). In FIG. 3 the system (10) is shown at the quay (Q) during high tide, and again there is adequate clearance between the vessel (12) and the base (14). However referring to FIG. 4, the system (10) is shown at the quay (Q) during low tide. In this location the vessel (12) and base (14) are shown in contact with one another and with the vessel (12) partially exposed or raised out of the water. This indicates that there is not sufficient water depth at this location to allow the vessel (12) to remain afloat with the base (14) secured there beneath, and without the base (14) contacting the seabed (B) at the quay (Q). However the system (10) of the present invention is designed to allow the base (14) to support the vessel (12) thereon when partially or fully out of the water, for example as illustrated in FIG. 4. In use as the tide recedes, the water level around the system (10) slowly drops until the legs (18) of the base (14) come into contact with the seabed (B). This will arrest the further drop of the system (1)) despite the continuing drop in water level. The weight of the vessel (12) will now begin to bear down on the base (14) as the vessel is partially or fully exposed by the dropping water. However, the legs (18) of the base (14), and the interface between the base (14) and the vessel (12) are designed to bear the load of the vessel (12) in a stable manner, as described in more detail hereinafter, allowing the system (10) to remain safely at such a location during low tide.

By providing the vessel (12) and the base (14) with the increased strength necessary to allow the vessel (12) to be borne by the base (14), the system (10) can be left at locations which would otherwise have insufficient water depth, during low tide, and which would therefore be unsuitable for deployment of the system (10). This significantly increases the number of locations at which the system (10) can be deployed without the risk of damage to the system (10) during low tide. If the system (10) were not so designed and was positioned at such a location during low tide, significant damage could occur to both the vessel (12) and the base (14) as a result of the base (14) carrying the full load of the vessel (12) thereon.

As well as providing sufficient structural reinforcement to the vessel (12) and base (14) to achieve the above mentioned support functionality, the vessel (12) and base (14) preferably defined a number of coupling portions in the form of the projections (20) and sockets (22), which enable interlocking of the vessel (12) and base (14). These coupling portions then prevent relative movement of the vessel (12) and base (14), in particular when standing out of the water. This ensures that the vessel (12) does not slide partially or fully off the base (14) when raised out of the water, even is position at a slight angle to the horizontal. It also allows work to be carried out on the vessel (12) and base (14), or the turbine (not shown) mounted to the base (14), when the system (10) is raised out of the water.

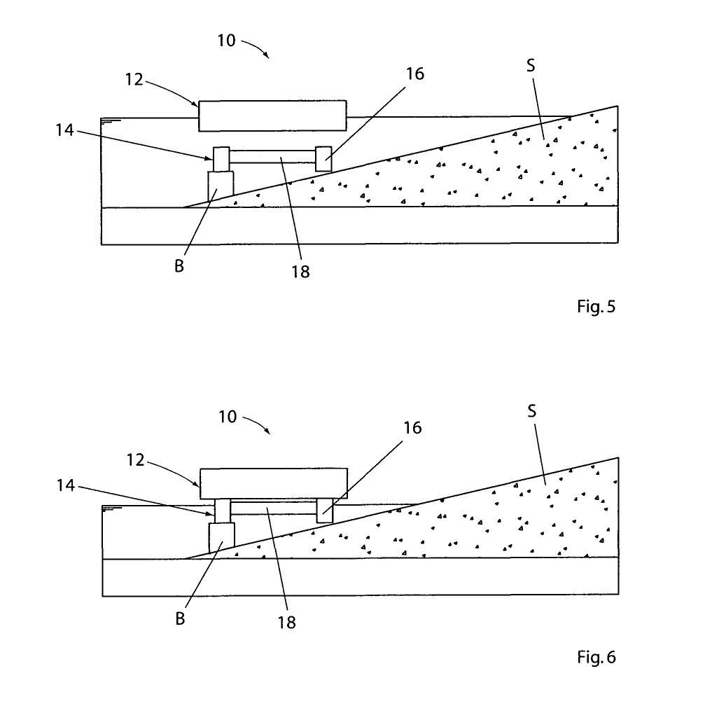

Referring now to FIGS. 5 and 6, the system (10) is shown in the water above a slip (S). Slips which are generally more widely used in areas of high tidal ranges, but make deployment of large systems relatively difficult, and which do not provide a suitable environment at which to dock such a system, for example for storage and/or maintenance or the like. However, the system (10) of the present invention may be deployed from and/or docked at such a slip (S) and at which during low tide the system (10) would be exposed, but can be left free standing as illustrated in FIG. 6. It may be necessary, depending on the gradient of the slip (S) to position a block (B) beneath one or more of the legs (16) in order to maintain a substantially horizontal orientation of the system (10). The block (B) could be preinstalled at the free end of leg (18) prior to low tide. The system (10), including a turbine if mounted thereto, can then be serviced while positioned on the slip (S) and during periods of low tide. This arrangement will also leave the underside of the base (14) and vessel (12) accessible for maintenance/inspection or the like.

The design of the system (10) in the preferred embodiment illustrated is such that when free standing out of the water as illustrated in FIGS. 4 and 6, the majority of the weight of the vessel (12) is transferred directly through the legs (16). The legs (16), and in particular an underside thereof, are designed to allow the entire system to be stood freely out of the water while remaining stable, and to transfer most, if not all of the load of the vessel (12) to the ground on which the base (14) is standing. To this end, the vessel (12) and base (14) are preferably designed such that the vessel (12) contacts only the upper end of each of the legs (16) and preferably does not contact any of the struts (18) of the base (14). The upper end of the legs (16), in particular the projection (20), and the underside of the vessel (12), in particular the socket (22), are preferably suitably reinforced to bear the loads applied thereto when freestanding out of the water.

The present invention therefore provides a simple yet effective means of allowing a hydroelectric turbine system to stand freely out of the water without requiring any change in the position/orientation of the base (14) from the position in which it is normally stored beneath the vessel (12) for deployment purposes. This then increases the number of viable locations from which the system 10 can be deployed and/or serviced or the like.

1. A hydroelectric turbine support system comprising a vessel for transporting the turbine to a deployment site; a base on which the turbine is supportable, the base and vessel being designed to allow the base to be retained beneath the vessel; wherein the base and vessel are adapted to facilitate the stable support of the vessel above the base when the system is partially or fully out of water.

2. A hydroelectric turbine support system according to claim 1 in which the base and vessel are designed to allow the base to support the vessel while the base is free standing.

3. A hydroelectric turbine support system according to claim 1 in which the vessel and the base are provided with complementary coupling portions.

4. A hydroelectric turbine support system according to claim 3 in which the coupling portions substantially prevent the relative movement of the base and vessel when the system is partially or fully out of water.

5. A hydroelectric turbine support system according to claim 3 in which the coupling portions comprise at least one projection provided on or formed integrally with the base and a complementary socket provided on or formed integrally with the vessel.

6. A hydroelectric turbine support system according to claim 5 in which the projection and/or socket are tapered to assist in locating the projection in the socket.

7. A hydroelectric turbine support system according to claim 5 in which the base comprises at least one leg an upper end of which defines one of the complementary coupling portions.

8. A hydroelectric turbine support system according to claim 7 in which the base is free standing on a lower end of the at least one leg.

9. A hydroelectric turbine support system according to claim 6 in which the base comprises three legs each of which defines one complimentary coupling portion.

10. A hydroelectric turbine support system according to claim 1 in which the vessel is adapted to allow the turbine to be mounted to and supported by the base while the base is mounted beneath the vessel and supporting the vessel.

11. A method of supporting a hydroelectric turbine system comprising the steps of:
securing a base of the system beneath a vessel of the system;
positioning the system in a body of water at a location at which the water depth varies over time;
and allowing the base to contact and stand on a bottom of the body of water, and
therefore support the vessel at least partially out of the water during periods of low water depth.

12. A method according to claim 11 comprising the steps of:
prior to securing the base to the vessel, positioning the base of the system in a body of water;
locating the vessel above the base;
raising the base beneath the vessel to allow the base and vessel to be secured together.

13. A method according to claim 11 comprising the step of:
securing a turbine to the base once the base is secured beneath the vessel.
